(19) United States
(12) Patent Application Publication
(10) Pub. No.: US 2008/0066384 A1
(43) Pub. Date: Mar. 20, 2008

(54) Automatically Sliding Windows Without Sash

(76) Inventor: Jinzhang Yu, Zhejiang Province (CN)

Correspondence Address: SCHWEGMAN, LUNDBERG & WOESSNER, P.A., P.O. BOX 2938, MINNEAPOLIS, MN, 55402, US

(21) Appl. No.: 11/632,267

(22) PCT Filed: Jul. 14, 2005
(86) PCT No.: PCT/CN05/01045

§ 371 Date: Jan. 11, 2007

(30) Foreign Application Priority Data
Jul. 15, 2004 (CN) 200410068965.0

(51) Int. Cl. E06B 3/02

(52) U.S. Cl. 49/373; 49/372

(57) ABSTRACT

The present invention relates to an automatically sliding window without sash, comprising a frame body (1) having an upper slide groove and a lower slide groove formed therein, and an intelligent drive mechanism (3) being disposed at an upper portion of the frame body (1) and driving a window body to move horizontally. The window body includes a pane (2) and roller members (9) fixed to a lower edge portion of the pane (2), and the drive mechanism (3) is engaged to an upper edge portion of the pane (2). The area of the window according to the present invention allowing the sunlight to pass through is increased significantly compared to those windows in the art since each window body almost completely consists of glass. The closing and opening of the window body can be controlled more conveniently by utilizing an intelligently controlled transmission mechanism. The sealing of the window is improved since a bidirectional multiple sealing is applied between the groove and the pane or the panes. The window according to the present invention can be maintained more conveniently. The present invention provides a window with a novel configuration and a good appearance, which overcomes all the shortcomings of a window having a window body with sashes in the art.

### TECHNICAL FIELD OF THE INVENTION

The present invention relates to an assembly for a building and more particularly to an automatically sliding window without sash.

### BACKGROUND OF THE INVENTION

A window is an assembly necessary for a building. A window with a novel configuration and a good appearance can ornament a building to a great extent. Conventional windows comprise a plurality of window bodies, each of which includes a sash and a pane enclosed by the sash. However, an area of the window bodies that allows the sunlight to pass through is reduced due to the presence of the sash that is usually made from a material such as aluminum or plastic steel, and is subject to the climate and environment. An aluminum sash has poor insulation in the summer or winter due to high thermal conductivity of aluminum and a plastic steel sash has lower strength and is prone to aging, discoloration and fading at its portion under sunlight. It is difficult to have a window with sashes repaired. In particular, the window with sashes may impair the appearance of a building aesthetically.

### SUMMARY OF THE INVENTION

An object of the present invention is to provide an automatically sliding window without sash that has an intelligent function.

In order to achieve the object of the present invention, an automatically sliding window without sash is provided, which comprises a frame body having an upper slide groove and a lower slide groove formed therein, and an intelligent drive mechanism being disposed at an upper portion of the frame body and driving a window body to move horizontally. Particularly, the window body includes a pane and roller members mounted to a lower edge of the pane, and the intelligent drive mechanism is engaged to an upper edge of the pane.

The area of the window according to the present invention allowing the sunlight to pass through is increased significantly compared to those windows in the art since each window body almost completely consists of glass. The closing and opening of the window body can be controlled more conveniently by utilizing an intelligently controlled transmission mechanism. The sealing of the window is improved since a bidirectional multiple sealing is applied between the groove and the pane or the panes. In addition, the window according to the present invention can be maintained more conveniently. The present invention provides a window with a novel configuration and a good appearance, which overcomes all the shortcomings of a window having a window body with sashes in the art.

### BRIEF DESCRIPTION OF THE DRAWINGS

FIG. 1 is a schematic diagram of a window according to the present invention;

FIG. 2 is an enlarged cross-sectional view taken along line A-A as shown in FIG. 1; and

FIG. 3 is an enlarged cross-sectional view taken along line B-B as shown in FIG. 1.

### EMBODIMENTS OF THE INVENTION

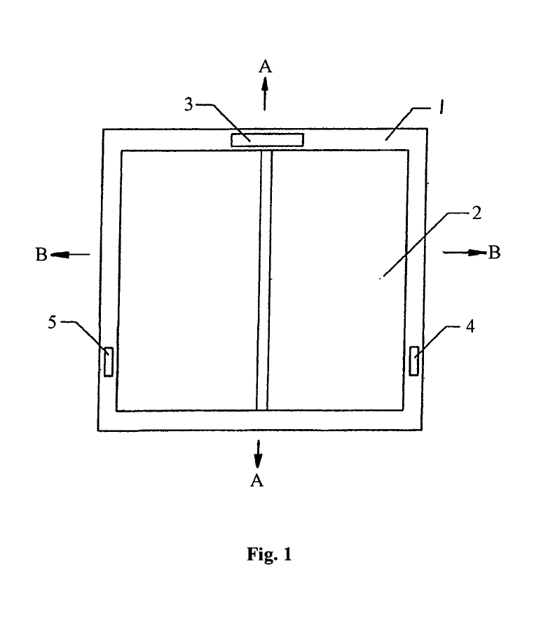

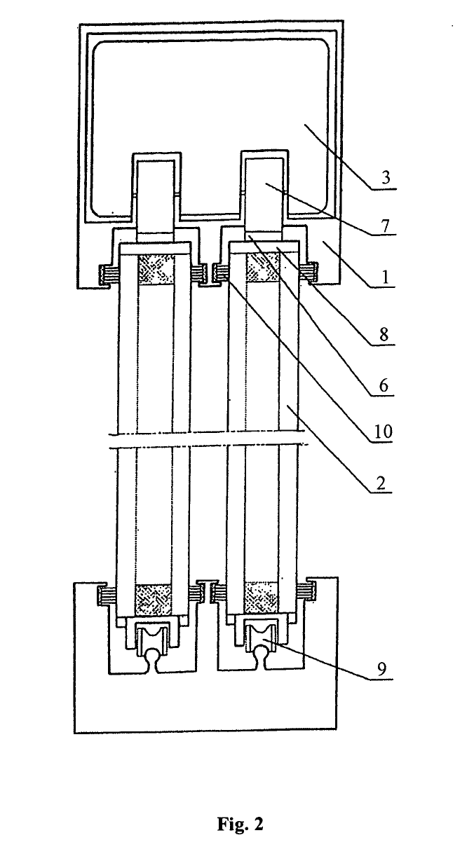

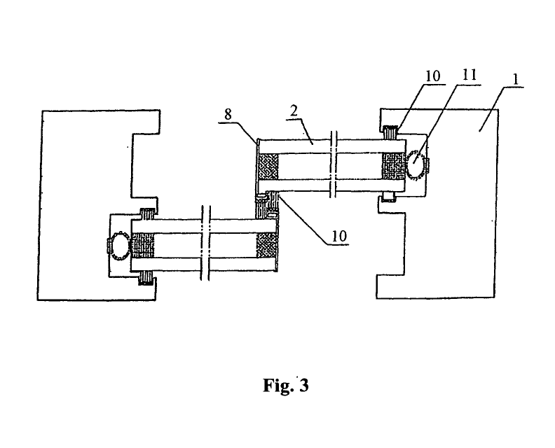

FIGS. 1-3 show an embodiment according to the present invention. A window of the embodiment comprises a frame body 1 having an upper slide groove and a lower slide groove formed therein, and an intelligent drive mechanism 3 that is disposed at an upper portion of the frame body 1 and drives a window body to move horizontally. The window body includes panes 2 and roller members 9 mounted to a lower edge portion of the panes 2. The intelligent drive mechanism 3 is engaged to an upper edge portion of the panes 2.

The frame body 1 is fixed to a wall of a building and may consist of a profile including a plurality of chambers and double grooves. The intelligent drive mechanism 3 disposed within an upper chamber of the frame body is an intelligent window driver as disclosed in Chinese Patent 200320122936.9, in which its control components and mechanical transmission components are integrated as a module and a chip technique is used to enhance capability of anti-interference. The driver described in this Chinese patent can be operated remotely, manually and intelligently.

The frame body 1 has a lower chamber providing two slide grooves in which two slide rails are provided respectively. The two slide rails may be separated from the frame body 1 or integrated with the frame body 1. If the two slide rails are formed with the frame body 1 integrally, the two slide rails may be covered by a stainless steel layer so that a wearing of the roller members and a friction force between the roller members and the two rails can be reduced. As an option, the two slide rails which are made in advance may be directly assembled into the slide grooves of the lower chamber. A draining chamber can be provided at a lower portion of the frame body for discharging seeper that intrudes into the frame body.

The panes 2 of the window bodies are made of glass, the number of which is determined in accordance with that of slide grooves in the profile used. The panes 2 are insertedly mounted within the slide grooves of the upper and lower portions of the frame body 1. The roller members 9 are fixed to the lower edge portion of the pane 2 and the roller member comprises a roller and a roller support. The roller may be made of a material such as nylon or stainless steel, and may be a ball bearing. Each pane 2 may be provided with two or more roller members 9 and the roller members supporting the pane 2 roll above the slide rail. The pane is of a rectangle and has three flat and straight end surfaces and one end surface (i.e. the upper edge of the pane) having a plurality of teeth directly formed thereon. The end surface with the teeth forms a rack 6. The teeth of the rack 6 are engaged to those on an output gear 7 of the intelligent drive mechanism 3 at the upper portion of the frame body so that a conversion from a rotation of the gear 7 into a translation of the rack 6 can be exploited. That is, the rotation of the output gear 7 can be converted into the translation of the pane 2 in the left or right direction along the slide rails to perform the opening and closing of the window.

The output gear 7 may be made of metal or engineering plastic.

The frame body 1 further includes two upright fames. A button 4 for controlling the operation of the pane and a switch 5 for manual operation of the pane as power is off are provided at the two upright frames, respectively. The button 4 and the switch 5 are electrically communicated with the drive mechanism 3 through conductive wires that are laid within chambers of the upright frames and an upper frame of the frame body. The button 4 and the switch 5 control the opening and closing of the window whether power is off or not. Each of the upright frames provides an upright groove. A positioning sealing rubber strip 11 in the form of a hollow rubber column is contained within the upright groove and is fixed to a bottom wall of the upright groove. When the pane retracts into one of the upright grooves, the rubber strip 11 can prevent the pane 2 from directly impacting the bottom wall of the upright groove. As being pressed by the pane 2, the strip 11 is deformed and closely joints to the side edge of the pane serving as a seal. The rubber strip can be provided within two opposite upright grooves or within one of them. The rubber strip 11 may have a length equal to the height of the upright groove and may be made of soft PVC modified by nitrile rubber.

In order to strengthen the rack 6 at the upper edge portion of the pane 2, the rack 6 is covered by a metal covering 8 which has a racked shape in match with the teeth of the rack 6. The metal covering 8 is made of a thin sheet of stainless steel or aluminum alloy. An adhesive can be applied between the rack and the covering so as to enhance the binding therebetween. In order to reduce noise caused by an engagement movement between the rack and the output gear, either or both of the output gear and the covering 8 are made of non-metal material, such as engineer plastic. For the convenience of the process, in addition to getting the pane to form a rack at its upper edge portion, a metal or plastic rack which is separately formed in advance can be affixed to an upper end surface of the pane 2 directly or after the upper end surface of the pane is covered by a metal or plastic covering. Alternatively, the entire periphery or opposite peripheral side surfaces of the pane 2 may be covered by a covering of stainless steel, aluminum alloy or plastic.

Each slide groove at the upper frame and a lower frame of the frame body 1 has opposite upright walls at which a seal recess for housing a sealing strip 10 is formed respectively. Alternatively, only at one of the opposite upright walls is provided a seal recess. The sealing strip 10 ensures the sealing between the pane 2 and the frame body 1. The sealing strip 10 can be a wool or adhesive strip. A plurality of rollers (not shown) may be provided at the opposite upright walls to hold the panes 2, which can ensure the pane sliding smoothly and not swinging within the slide groove so that the capability of wind pressure resistance is improved. Further, in order to ensure the sealing where two adjacent panes overlap, a sealing strip 10 is provided at a side surface of one pane facing the other pane of the two adjacent panes 2, which can adhere to the surface of the pane. Alternatively, a side surface of each pane facing the other pane is covered by a covering at which a recess is formed to receive a sealing strip 10. The sealing strips 10 mounted to the panes 2 may be a combination of a wool strip and an adhesive strip. As such, the window according to the invention is configured to be of an overlapped sealing structure hereby improving the sealing performance of the window.

In order to optimize sound insulation, noise reduction, heat preservation and energy saving, the pane 2 is configured to be a hollow glass that will have better properties of heat preservation and sound insulation. A single layer glass can be used so as to reduce the cost and a multilayer glass such as a three-layer glass may also be used if the cost allows.

1. A automatically sliding window without sash, comprising a frame body, providing an upper portion and a lower portion and having an upper slide groove and a lower slide groove respectively formed with the upper portion and he lower portion;
a window body including panes and roller members fixed to an lower edge portion of the pane; and
and an intelligent drive mechanism being disposed at the upper portion of the frame body
wherein the intelligent drive mechanism is engaged to an upper edge portion of the pane so that the window body can be driven to move horizontally.

2. The automatically sliding window without sash according to claim 1, wherein is provided at an output end of the drive mechanisms to engage a rack which is formed at an upper edge surface of the pane.

3. The automatically sliding window without sash according to claim 2, wherein a metal or non-metal covering in the shape of a rack is provided at the upper edge of the pane.

4. The automatically sliding window without sash according to claim 3, wherein the metal covering is made of stainless steel or aluminum alloy.

5. The automatically sliding window without sash according to claim 3, wherein the non-metal covering is made of plastic.

6. The automatically sliding window without sash according to claim 1, wherein a sealing strip is provided between the pane and an inside wall of the slide grooves of the frame body.

7. The automatically sliding window without sash according to claim 6, wherein a sealing strip is provided between two panes.

8. The automatically sliding window without sash according to claim 7, wherein the sealing strip is a wool or adhesive strip.

9. The automatically sliding window without sash according to claim 1, wherein the pane is a hollow glass, a single layer glass or a multilayer glass.

10. The automatically sliding window without sash according to claim 6, wherein is a hollow glass, a single layer glass or a multilayer glass.

11. The automatically sliding window without sash according to claim 1, wherein the roller member comprises a roller and a roller support that is fixed to the lower edge portion of the pane, and a rail is provided within a lower chamber of the frame body to allow the roller to roll therealong.

12. A automatically sliding window without sash, comprising
a frame body providing an upper portion and a lower portion, and having an upper slide groove and a lower slide groove respectively formed within the upper portion and the lower portion;
a window body including two panes and roller members fixed to an lower edge portion of the pane; and
an intelligent drive mechanism being disposed at the upper portion of the frame body,
wherein the intelligent drive mechanism is engaged to an upper edge portion of the pane so that the window body can be driven to move horizontally.

13. The automatically sliding window without sash according to claim 12, wherein the drive mechanism comprises two gears at its output end, each engaging a rack which is formed at an upper edge surface of the pane.

14. The automatically sliding window without sash according to claim 13, wherein the roller member comprises a roller and a roller support that is fixed to the lower edge portion of the pane, and a rail is provided within a lower chamber of the frame body to allow the roller to roll therealong.
